(19) United States
(12) Patent Application Publication
(10) Pub. No.: US 2010/0277303 A1
(43) Pub. Date: Nov. 4, 2010

(54) SYSTEM AND METHOD FOR DYNAMICALLY DISPLAYING WEATHER-RELATED HEALTH INFORMATION

(75) Inventors: Chaucer CHIU, Taipei (TW); Frances Dai, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei City (TW)

(21) Appl. No.: 12/434,101

(22) Filed: May 1, 2009

(51) Int. Cl. G01W 1/00

(52) U.S. Cl. 340/522

(57) ABSTRACT

This specification discloses the system and method for dynamically displaying weather-related health information. It establishes an item table database to actively collect weather data and analyze them according to the item table, thereby providing weather-related health information. It solves the problem of time-consuming and complicated searching in the prior art for collect and analyzing weather-related health information. Therefore, the invention can effectively use system and network resources to retrieve weather-related health information.

### BACKGROUND OF THE INVENTION

1. Field of Invention

The invention relates to a system for dynamically displaying weather-related health information and the method thereof. More explicitly, the invention relates to the system and method that actively provide current weather-related health information and dynamically display it.

2. Related Art

Weather has great effects on human health, as seen in the following examples. Take the rheumatism as an example. Even though its formation is not directly related to the weather, low temperatures or high humidity can induce it. Also, a cold weather is likely to induce heart attacks and strokes. A humid and hot summer does not only increase the possibility of sunstroke, it is also the season for germs to proliferate. Therefore, people are also likely to get gastrointestinal diseases or food poisoned. In recent years, human destruction of global environment has made the weather pattern different from before. Therefore, one cannot ignore the effects of weather on human health.

Generally speaking, people often obtain various kinds of weather information from television or the Internet. Knowing the weather enables people to make preparations. Most importantly, people can watch possible effects on various diseases due to weather changes. For example, in a dry and cold day with low UV radiation and high dust density in the air, it may induce itches, asthma, myocardial infarct, stroke, etc. Aside from patients with cardiovascular disease, diabetes patients also have to watch various kinds of infections so as not to aggravate the illness.

However, for a busy person, it is very time-consuming to follow and collect the information of weather, diseases, and their possible relations, not to mention further analyzing the implications of the current weather. Generally speaking, the weather information collected from the Internet is most complete. Nonetheless, this is more difficult for people who are not familiar with computers.

In summary, the prior art long has the problem that it is time-consuming and complicated to collect weather information. It is therefore imperative to provide a better technology.

### SUMMARY OF THE INVENTION

In view of the foregoing, the invention discloses system and method for dynamically displaying weather-related health information.

The disclosed system for dynamically displaying weather-related health information includes an item table database, an extracting module, a comparing module, a generating module, a graphic module, and a displaying module. The item table database has several item tables. Each item table contains several data ranges and the corresponding risk indices. The extracting module has an extracting condition. When this extracting condition is valid, the system establishes a connection with a web site and extracts multiple weather data from it. The comparing module compares the weather data with the data ranges in the item tables, generating a list to evaluate the corresponding risks. The generating module combines the weather data and the comparison result to generate health information. The graphic module produces plots for the health information. The displaying module displays the health information plots.

The disclosed method for dynamically displaying weather-related health information predetermines an extracting condition and several item tables. Each of the item tables with an item name has multiple data ranges and the corresponding risk indices. First, after the extracting condition is valid, a connection to a web site is established to extract multiple weather data. The weather data are compared with the data ranges in the item tables, generating a list to evaluate the corresponding risks. The weather data and the comparison result are combined to generate health information. The graphic module produces plots for the health information. The health information is then displayed graphically.

The system and method disclosed herein differ from the prior art in that the invention has item tables and that the invention actively collects the weather data and analyzes them according to the item tables, thereby providing weather-related health information. Through the above-mentioned technique, the invention can conveniently and immediately obtain weather-related health information, making full use of system and network resources.

### BRIEF DESCRIPTION OF THE DRAWINGS

The invention will become more fully understood from the detailed description given herein below illustration only, and thus is not limitative of the present invention, and wherein:

FIG. 1 is a block diagram of the disclosed system for dynamically displaying weather-related health information;

FIG. 2 is a flowchart of the disclosed method for dynamically displaying weather-related health information;

FIG. 3 is the flowchart of the suggestion steps in the disclosed method for dynamically displaying weather-related health information;

FIG. 4 is a schematic view of the displayed weather-related health information;

FIG. 5A shows the input for suggestions;

FIG. 5B shows the output for suggestions; and

FIG. 6 shows the data in the suggestion database.

### DETAILED DESCRIPTION OF THE INVENTION

The present invention will be apparent from the following detailed description, which proceeds with reference to the accompanying drawings, wherein the same references relate to the same elements.

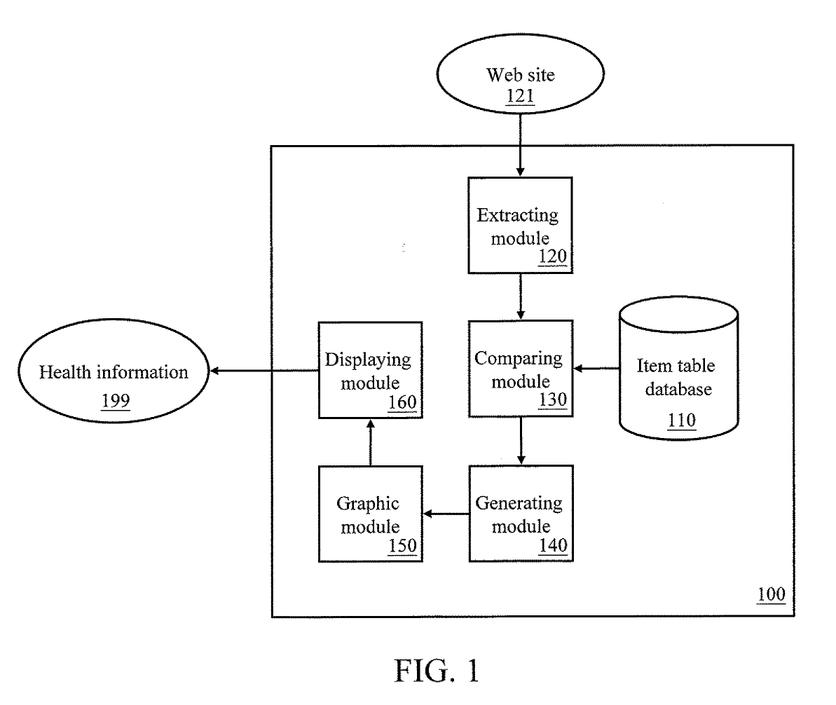

FIG. 1 is a block diagram of the disclosed system for dynamically displaying weather-related health information. As shown in the drawing, the system 100 for dynamically displaying weather-related health information includes an item table database 110, an extracting module 120, a comparing module 130, a generating module 140, a graphic module 150, and a displaying module 160. The item table stored in the item table database 110 is like the following:

| | Data range | | |
|---|---|---|---|
| Item | Relative humidity | Temperature | |
| name | (%) | (° C.) | Risk index |
| Sunstroke | <50 | <31 | Low |
| | | 31-35 | Medium |
| | | 36-39 | Slightly high |
| | | >39 | High |
| | 50-59 | <30 | Low |
| | | 30-34 | Medium |
| | | 35-39 | Slightly high |
| | | >39 | High |
| | 60-80 | <30 | Low → Medium |
| | | 30-33 | Medium |
| | | 34-38 | Slightly high |
| | | >38 | High |
| | >80 | <28 | Low → Medium |
| | | 28-32 | Medium → Slightly high |
| | | 33-37 | Slightly high → High |
| | | >37 | High |

The item name of this item table is ‘sunstroke’. It only uses ‘relative humidity (%)’ and ‘temperature (° C.)’ and their data ranges as an example. This table may contain other kinds of data ranges. Moreover, there may be item tables for ‘asthma’, ‘respiratory infection’, ‘hypertension’, etc. Each item table has an item name and several ranges of weather data. Each data range has a corresponding risk index. To present in a logical way, the applications of this item table will be detailed later.

The extracting module 120 has an extracting condition. When this extracting condition is valid, the system connects to a web site 121 and extracts weather data from there. For example, the extracting condition can be set as a period of 12 hours. That is, the extracting condition holds every 12 hours. Suppose the latest time of extracting weather data from the web site 121 is 8 AM this morning. Then the next time the extracting condition holds will be 8 PM this evening. Besides, the extracting module 120 can be set to connect to the web site 121 at a fixed time. The weather data on the web site 121 are compared with those extracted last time. If there is a difference, then the extracting condition is satisfied. More explicitly, the extracting module 120 can be set to check whether the weather data on the web site 121 have been updated every few hours. If they are updated, then the new weather data are extracted.

The comparing module 130 compares the extracted weather data with the data ranges of the same type in various item tables of the item table database 110, thereby obtaining the corresponding risk indices related to the weather data. It then generates a comparison result that contains several item names and the corresponding risk indices. Take the 11/7 morning of Taipei city as an example. The weather data are as follows.

| | |
|---|---|
| Location | T1 (Taipei City) |
| Observation time | AM 10:00 |
| Cloud | Few |
| Temperature (° C.) | 28.1 |
| Wind (level) | 1 |
| Gust (level) | — |
| Visibility (km) | — |
| Relative humidity (%) | 72 |
| Atmospheric pressure | 1014.3 |
| (100 Pa) | |
| Precipitation (mm) | 0 |
| Ultraviolet index | 5 |
| Air quality | Poor |

Take the item table of the item name ‘sunstroke’ as an example. The system first compares the relative humidity and then the temperature. In the weather data, the relative humidity ‘72’ falls in the data range ‘60-80’ of the item table, and the temperature ‘28.1’ in the range of ‘<30’. Therefore, the corresponding probability of getting sunstroke is ‘low→medium’. The comparing module 130 uses this method to find the risk indices from all the item tables. Eventually, it generates a comparison result that contains several item names and the corresponding risk indices for the item names.

The generating module 140 combines the weather data extracted by the extracting module 120 with the comparison result produced by the comparing module 130 to generate health information 199. The health information 199 can have the following format:

2008/11/07 Friday Taipei City
Weather: Sunny
Atmospheric pressure: Normal
Outdoor temperature: 28° C.
Wind: Level 1
Precipitation probability: 10%
Relative humidity: 72%
UV index: 5

Risk index:

| | |
|---|---|
| Temperature: Medium | Cerebral infarction: Medium |
| Hypertension: Medium | Cerebral hemorrhage: Medium |
| Sunstroke: Low to medium | Myocardial infarction: Medium |
| Air-conditioning disease: High | Coronary disease: Medium |
| Respiratory infection: High | |
| Asthma: High | |

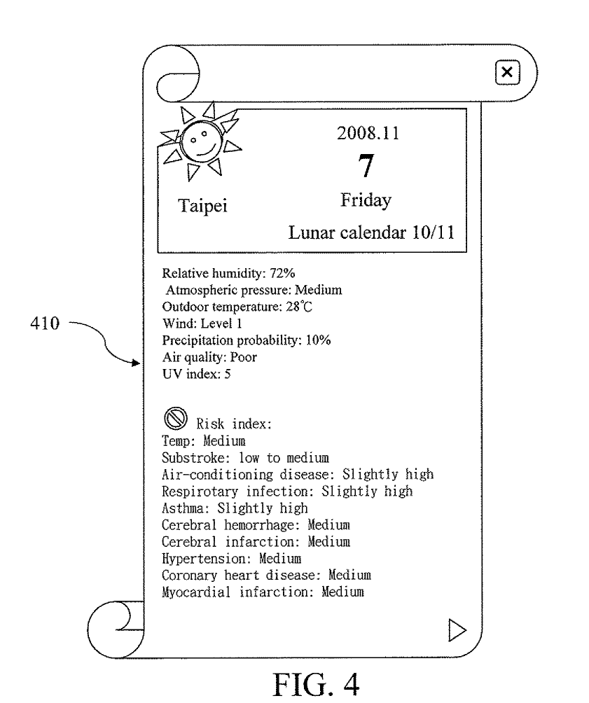

The graphic module 150 follows the user's preferences to produce plots for the health information 199. The displaying module 160 displays the graphic health information 199. FIG. 4 is a schematic view of the displayed weather-related health information. The graphic health information 199 is a health information window 410.

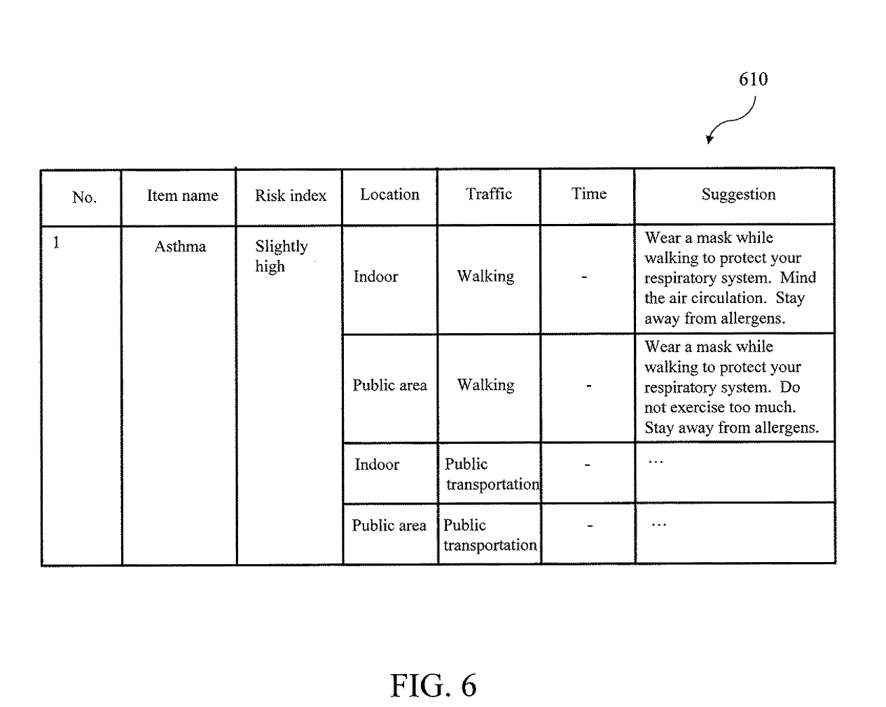

Besides, the disclosed system 100 for dynamically displaying weather-related health information further includes a suggestion database (not shown). In table formats, it stores many suggestion data as source data for the comparing module 130 to perform subsequent comparisons. The suggestion data tables in the suggestion database have many item names. For each item name, there is at least one risk index, several locations, several traffics, several times, and several suggestions. The suggestion data table 610 in FIG. 6 only lists one item name ‘asthma’. Corresponding to ‘asthma’, the risk index shows ‘high’ and there are several locations, traffics, and times with the high risk index, along with suggestions. The ‘time’ column has ‘-’ for all, meaning that the risk index ‘high’ of ‘asthma’ does not refer to time as a criterion.

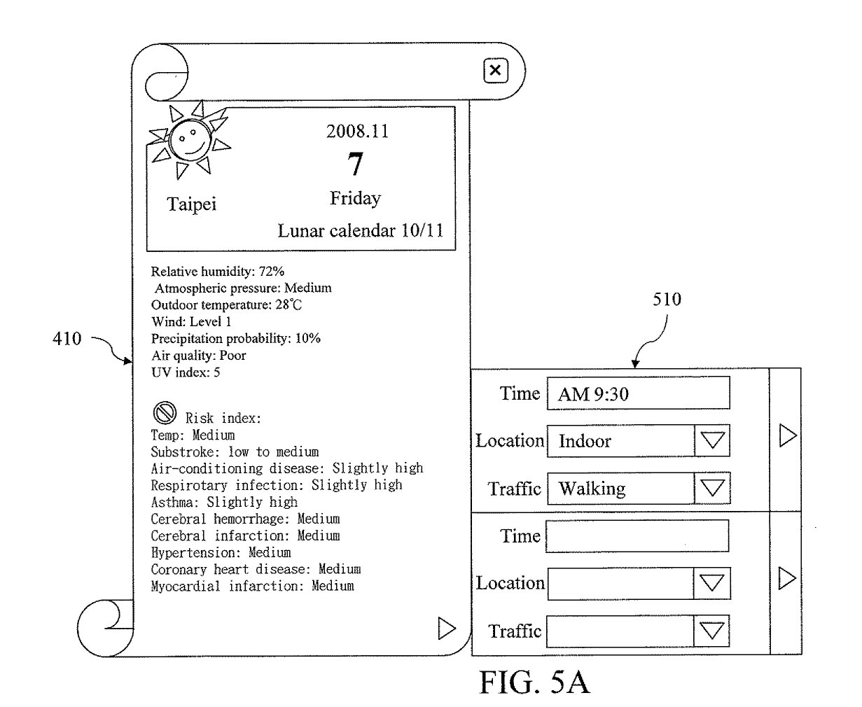

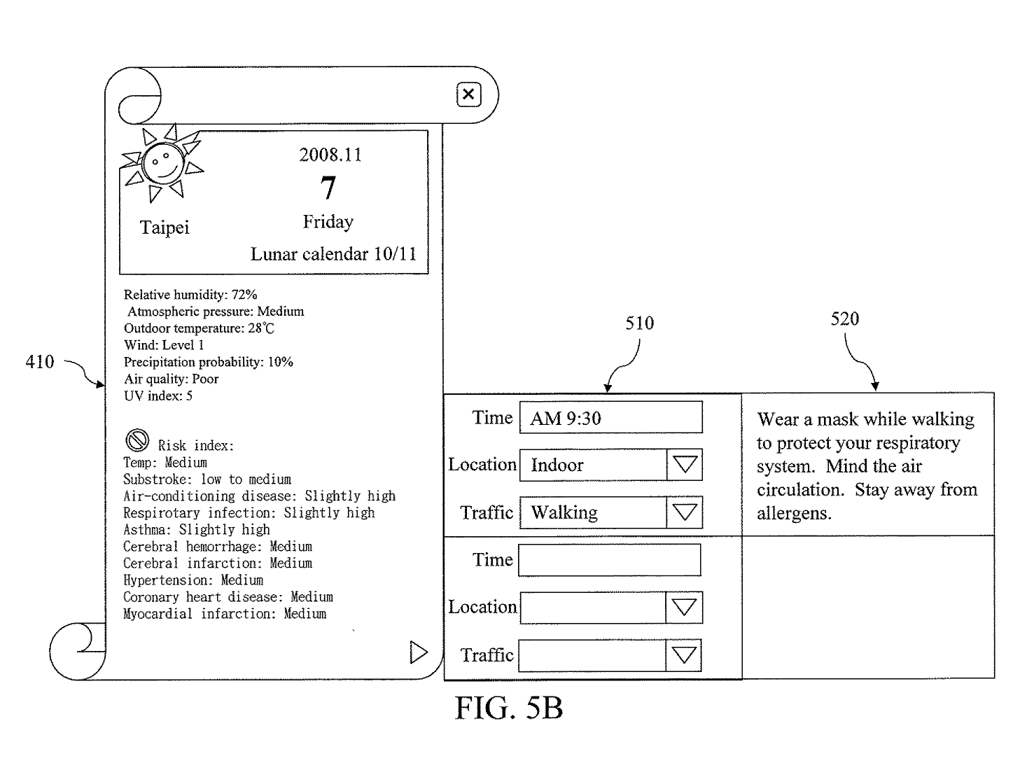

The comparing module 130 uses the item name entered by the user in real time, activity information, and the health information 199 to find in the suggestion database the corresponding suggestion data. The suggestion data are displayed by the displaying module 160. Besides, the comparing module 130 can use one or several items preset by the user to find suggestion data appropriate for the user. For example, the comparing module 130 compares the generated health information 199, the user preset ‘asthma’ item, and the activity information 510 entered in real time: ‘AM 9:30’, ‘indoor’, ‘walking’ (see FIG. 5A) with the suggestion data in the suggestion database. The health information 199 is used to find the user-preset item ‘asthma’. Since the risk index corresponding to the item is ‘high’, four suggestions are found form the suggestion data 610 (see FIG. 6) in the suggestion database. Afterwards, the location ‘indoor’ and the traffic ‘walking’ entered by the user are further compared to find one suggestion: ‘Please . . . while walking; mind the indoor air circulation, . . . allergens’. In particular, time is not one of the reference items. Please refer to the suggestion 520 shown in FIG. 5B. The suggestion 520 includes the suggestion data for the comparison of the item ‘asthma’. The suggestion data are displayed by the displaying module 160 in the health information window 410.

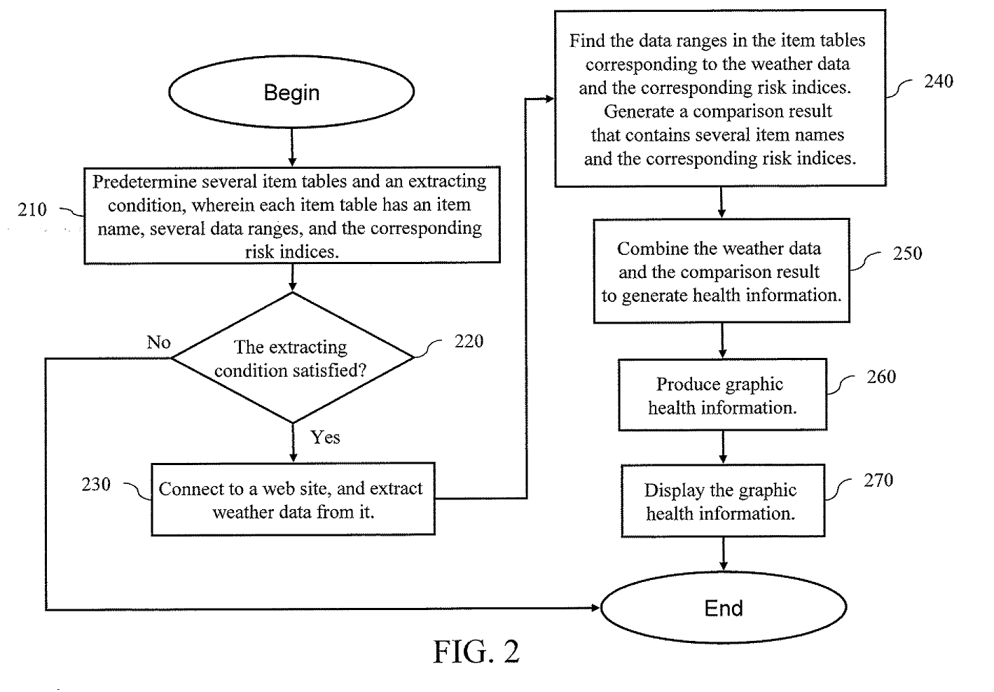

FIG. 2 is a flowchart of the disclosed method for dynamically displaying weather-related health information. First, the invention predetermines an extracting condition and several item tables. Each item table contains an item name, several data ranges, and the corresponding risk indices (step 210). When the extracting condition is satisfied (step 220), a connection to a web site 121 is established in order to extract multiple weather data from the web site 121 (step 230). The weather data are then compared with the corresponding data ranges in each of the item tables, giving the corresponding risk indices. A comparison result that contains several item names and the corresponding risk indices is generated (step 240). The extracted weather data and the comparison result are combined to form health information 199 (step 250). The health information 199 is then rendered graphically (step 260). The graphic health information 199 is displayed (step 270).

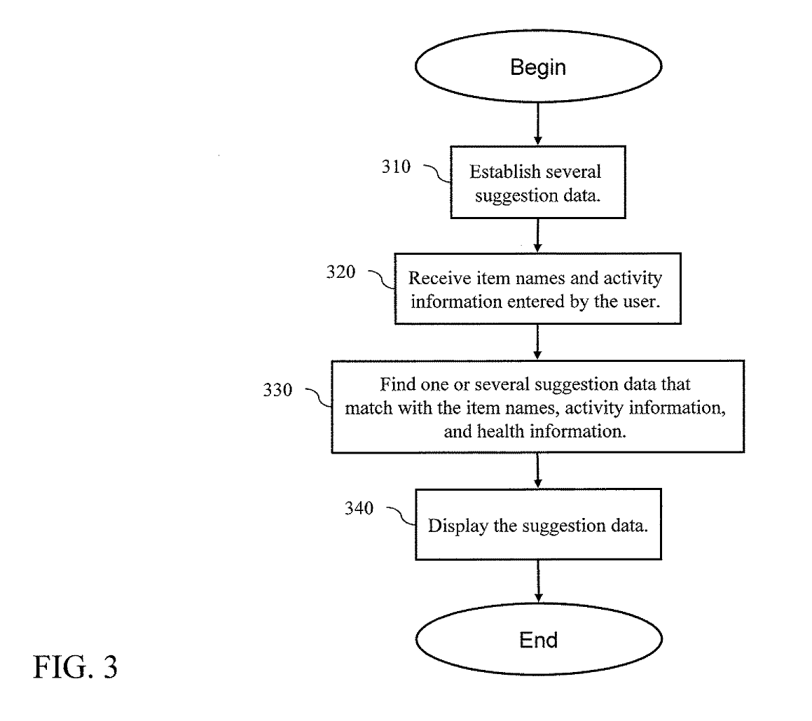

As described before, the extracting condition can be a time period. Or the web site 121 is periodically connected to check whether the weather data are updated. If they are, then the weather data are extracted. Step 260 may even render the health information 199 graphically according to the preset preferences. Please refer to FIG. 3. In addition to the above-mentioned steps, the method further includes the following ones: Establish several suggestion data (step 310); receive item name and activity information entered by the user (step 320); find one or several suggestion data that match with the item name, activity information and health information 199 (step 330); and display the suggestion data 199 (step 340). The graphic health information 199 can be displayed as a desktop according to the preferences or a window shown in FIG. 4.

In summary, the invention differs from the prior art in that it establishes an item table database and that it actively collect weather data and analyzes them according to the item tables, thereby providing weather-related health information. The disclosed technique can solve problems existing in the prior art. Therefore, system and network resources can be effectively utilized to obtain weather-related health information periodically.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A system for dynamically displaying weather-related health information, comprising;
an item table database, which stores a plurality of item tables, each of which contains an item name, a plurality of data ranges, and corresponding risk indices;
an extracting module containing an extracting condition to establish a connection with a web site when the extracting condition holds and to extract a plurality of weather data from the web site;
a comparing module, which uses the item tables in the item table database to find out the data ranges covering the weather data along with the corresponding risk indices and generates a comparison result that contains the plurality of item names and the corresponding risk indices;
a generating module, which combines the weather data and the comparison result to generate health information;
a graphic module, which renders the health information graphically; and
a displaying module, which displays the graphic health information.

2. The system for dynamically displaying weather-related health information of claim 1 further comprising a suggestion database that stores a plurality of suggestion data as data sources for the comparing module to extract according to activity information entered by a user.

3. The system for dynamically displaying weather-related health information of claim 2, wherein the comparing module finds one or several suggestion data from the suggestion database that match the item name, activity information entered by the user and health information.

4. The system for dynamically displaying weather-related health information of claim 1, wherein the extracting condition is a time period or an update of the weather data.

5. The system for dynamically displaying weather-related health information of claim 1, wherein the graphic health information is set as a window or a desktop.

6. A method for dynamically displaying weather-related health information, comprising the steps of:
predetermining a plurality of item tables and an extracting condition, each of the item tables containing an item name, a plurality of data ranges, and corresponding risk indices;
establishing a connection to a web site when the extracting condition is satisfied and extracting a plurality of weather data from the web site;
finding data ranges in the item tables that cover the weather data and the corresponding risk indices, and generating a comparison result that contains a plurality of item names and the corresponding risk indices;
combining the weather data and the comparison result to generate health information;
rendering the health information graphically; and
displaying the graphic health information.

7. The method of claim 6 further comprising the steps of:
establishing a plurality of suggestion data;
receiving item name and activity information entered by a user;
finding one or several suggestion data that match with the item, activity information, and health information; and
displaying the suggestion data.

8. The method of claim 6, wherein the extracting condition is a time period or update of weather data.

9. The method of claim 6, wherein the graphic health information is set as a window or desktop.
